(19) United States
(12) Patent Application Publication
(10) Pub. No.: US 2025/0231041 A1
(43) Pub. Date: Jul. 17, 2025

(54) METHOD AND SYSTEM FOR PROVIDING TRAJECTORIES FOR AT LEAST ONE VEHICLE

(71) Applicant: Volkswagen Aktiengesellschaft, Wolfsburg (DE)

(72) Inventors: Niklas Koch, Tappenbeck (DE); Jana Seeland, Wolfsburg (DE); Christian Hopp, Wolfenbüttel (DE)

(21) Appl. No.: 19/018,105

(22) Filed: Jan. 13, 2025

(30) Foreign Application Priority Data
Jan. 11, 2024 (DE) 10 2024 200 244.5

(51) Int. Cl. G01C 21/36; B60W 60/00; G01C 21/34

(52) U.S. Cl. CPC G01C 21/3691; B60W 60/005; G01C 21/3492; B60W 2556/45

(57) ABSTRACT

A method for providing trajectories for at least one vehicle. At least one trajectory is generated by a vehicle or another source. A confidence measure is assigned to the at least one trajectory. The at least one trajectory is received by at least one vehicle and is used in consideration of the assigned confidence measure. A system for providing trajectories for at least one vehicle has at least one device for providing at least one trajectory generated by a vehicle or another source. A confidence measure is assigned or can be assigned to the at least one trajectory. At least one vehicle receives the trajectory and uses it in consideration of the assigned confidence measure.

### CROSS-REFERENCE TO RELATED APPLICATION

This application claims the priority, under 35 U.S.C. § 119, of German Patent Application DE 10 2024 200 244.5, filed Jan. 11, 2024; the prior application is herewith incorporated by reference in its entirety.

### FIELD AND BACKGROUND OF THE INVENTION

The method relates to a method and a system for providing trajectories for at least one vehicle.

Storing trajectories for semiautomated or automated driving of a vehicle on a central server (backend) and transmitting them as needed to vehicles is known. However, a context can change with respect to these trajectories, in particular with regard to the surroundings and/or boundary conditions. Such changes are first noticed, however, when the trajectory is traveled again.

### SUMMARY OF THE INVENTION

The invention is based on the object of improving a method and a system for providing trajectories for at least one vehicle.

With the above and other objects in view there is provided, in accordance with the invention, a method for providing trajectories for at least one vehicle. The method comprises:
providing at least one trajectory that is generated by a vehicle or by another source selected from the group consisting of a simulation, an infrastructure operator, and another vehicle;
assigning a confidence measure to the at least one trajectory;
receiving the at least one trajectory by at least one vehicle; and
using the at least one trajectory by the at least one vehicle in consideration of the assigned confidence measure.

In other words, the invention achieves the above and other objects by way of a method for providing trajectories for at least one vehicle, wherein at least one trajectory generated by a vehicle or another source (e.g., simulation, infrastructure, other vehicles) is provided, wherein the at least one trajectory is assigned or will be assigned a confidence measure, wherein the provided at least one trajectory is received by at least one vehicle, and wherein the at least one trajectory is used in consideration of the assigned confidence measure.

Furthermore, in particular a system for providing trajectories for at least one vehicle is provided, comprising at least one device for providing at least one trajectory generated by a vehicle or another source, wherein the at least one trajectory is assigned or can be assigned a confidence measure, and at least one vehicle, wherein the at least one vehicle is configured to receive the at least one trajectory provided and to use the at least one trajectory in consideration of the assigned confidence measure.

The method and the system enable a value to be assigned to a provided trajectory, on the basis of which it can be decided how strongly the provided trajectory can be trusted. For this purpose, a confidence measure is assigned to the trajectory. Proceeding from this assigned confidence measure (or the value of the confidence measure) it can be decided in which manner the provided trajectory will be implemented by the receiving vehicle.

The at least one trajectory can be, for example, a trajectory related to trained parking. Furthermore, the at least one trajectory can also be a trajectory in flowing traffic, which was learned on a journey, for example. The trajectory in particular comprises a set of assigned positions and/or orientations of the vehicle, in particular in the form of geographic coordinates and/or angle specifications. Furthermore, a velocity and/or an acceleration can also be part of the trajectory. Furthermore, control data and/or metadata (e.g., surroundings data, context data, etc.) can also be part of the trajectory.

In the vehicle, the method steps are in particular carried out by means of a control device configured for this purpose.

Parts of the system, in particular the at least one device and a control device in the vehicle, can be designed individually or in combination as a combination of hardware and software, for example, as program code executed on a microcontroller or microprocessor. However, it can also be provided that parts are designed individually or in combination as an application-specific integrated circuit (ASIC) and/or a field-programmable gate array (FPGA). The at least one device and the control device in particular each comprise at least one computing device and at least one memory. Furthermore, a communication device can be provided in each case.

In accordance with a feature of the invention, the at least one trajectory is provided by means of a central server. Such a central server can be configured, for example, to collect trajectories generated by vehicles and/or by another source, for example, with the aid of simulations, and to provide these collected trajectories to the at least one vehicle as needed.

According to one embodiment of the invention, the central server checks and/or determines and/or assigns the confidence measure. In this way, a central instance for checking and/or determining and/or assigning the confidence measure can be provided. The server can in particular also perform an initial determination of the confidence measure in this case, in particular on the basis of the trajectory itself and/or on the basis of (meta-) data assigned to the trajectory, such as a context, specifications on the source which has generated the trajectory, etc.

In accordance with an added feature of the invention, the central server checks and/or determines and/or assigns the confidence measure repeatedly and/or regularly. In this way, the confidence measure assigned to a trajectory can always be kept current.

In accordance with another feature of the invention, the receiving (at least one) vehicle checks and/or determines and/or assigns the confidence measure. In this way, the receiving vehicle itself can also check and/or determine and/or assign the confidence measure. This in particular permits the most current possible value to be determined for the confidence measure, since this can take place immediately before the use of the trajectory by the vehicle.

In accordance with again another feature of the invention, the confidence measure is determined in consideration of an age and/or a last use of the at least one trajectory. In this way, a currency or a sustained validity of the at least one trajectory can be taken into consideration. This is based on the concept that the older the at least one trajectory is or the longer ago the time of the last use of the at least one trajectory is, the lower the confidence in the at least one trajectory is. It is presumed in particular in this case that trajectories which are used rarely age faster. Those which are used frequently, in contrast, age slower. The cause of this is that the probability that changes have occurred in the surroundings of the at least one trajectory is greater the more time has passed. In particular, a value for the currency of the at least one trajectory starts with a positive value after the generation or after the last check, wherein the value decreases with increasing age.

It can be provided that a severity of the aging can be taken into consideration by means of a damping factor. The damping factor is in particular a factor which indicates how severely the above-described initially positive value decreases with time.

In a further embodiment of the invention, the confidence measure is determined in consideration of a robustness and/or a stability of the at least one trajectory. A robustness and/or a stability of the at least one trajectory designates in this case in particular a measure of how strongly a (target) path corresponding with the at least one trajectory had to be adapted during the (last) journey along it. In other words, if the target path of the at least one trajectory can always be traveled along, a maximum of robustness and/or stability exists. In contrast, if it is only possible to travel along the target path partially each time, the value for the robustness and/or the stability is thus lower. Since the surroundings of the trajectory are subject to changes, it is in particular decisive how long the path of the trajectory to be traveled has not changed. In particular, dynamic influences, such as other road users, temporary construction sites, and/or permanent structural changes are relevant in this case. Positions of other parking vehicles, which change per se, changing vegetation, and/or barriers due to renovation measures require under certain circumstances an adaptation of the path to be traveled and can be detected and/or determined during the use of the at least one trajectory via a deviation of the traveled (adapted) actual path from a target path of the trajectory. The confidence measure can then be determined in consideration of an extent of the deviation and/or the adaptation and/or can be adapted upon the check.

If a newly generated trajectory is initially present, a statement cannot yet be made about the robustness and/or stability. As soon as a path corresponding with this trajectory has been traveled multiple times, however, the relevance of the path strengthens and a robustness and/or stability of the trajectory increases.

It can be provided that in addition a statistical scatter value is determined from the deviation of a respective journey (which can also be referred to as the trajectory fidelity) and is taken into consideration in the determination of the confidence measure. This scatter value can also be determined and taken into consideration in a location-resolved manner with respect to the trajectory.

In again a further embodiment of the invention, the confidence measure is determined in consideration of the surroundings in which the at least one trajectory is located. Environmental and/or surroundings influences, which can influence the confidence in the at least one trajectory, can be taken into consideration in this way. In particular fuzziness in the detection or training of the at least one trajectory can be taken into consideration in this way. Additionally or alternatively, fuzziness occurring during the use of the at least one trajectory can also be taken into consideration. In particular the following influencing factors can also be taken into consideration for this purpose:
the weather;
a position of the sun;
vegetation, which has different effects on the surroundings depending on the season;
a utilization by the road traffic;
a frequency of accidents;
a frequency of other road users, such as pedestrians, bicyclists, factory traffic, trams, etc.;
a roadway condition;
a frequency of barriers and congestion;
a diversion of other traffic streams into the area of the trajectory.

A factor or a parameter can be taken into consideration in each case for individual or multiple ones of these influencing factors when checking and/or determining the confidence measure.

It can be provided that the robustness and/or stability is taken into consideration in the age of the at least one trajectory. In particular, it can be provided that sections of the path or the trajectory assessed as very robust and/or stable age more slowly than sections assessed as less robust and/or stable. Proceeding therefrom, for example, the above-described damping factor can be determined.

In particular the following influencing factors can be taken into consideration in the determination of the robustness and/or stability:
an amount of information available (e.g., a large amount of vegetation or little/no vegetation, a large amount of change of the vegetation or little change of the vegetation; expressed, for example, in the form of a number of features which change or remain the same);
an information frequency (statistics of the changes);
an information consistency (i.e. how similar are deviations at the same point);
an information fidelity (i.e. how accurately was a target path of the at least one trajectory traveled)
identical or different update intervals (e.g., hourly, daily, monthly, . . . );
a period of time for how long no changes have taken place;
a relationship between a confirmation and a deviation of a target path of the at least one trajectory (for example, expressed as a relationship between a number of confirmed features and a number of deviating features).

A factor or parameter can be taken into consideration when determining the confidence measure in each case for individual or multiple ones of these influencing factors. The influencing factors can in particular be incorporated in the form of statistics and can be assessed at different strengths depending on the use of the at least one trajectory.

In accordance with a further embodiment of the invention, the confidence measure is determined in consideration of a similarity between properties of a vehicle, with which or for which the at least one trajectory was generated, and the receiving vehicle. A similarity of a source of the at least one trajectory in comparison to the receiving vehicle can be taken into consideration in this way. In particular, it can be taken into consideration in this way that a trajectory, which was generated with or for a vehicle, can be less suitable under certain circumstances for another vehicle which has different properties. In particular the following influencing factors can be taken into consideration here:
vehicle dimensions, in particular a wheelbase, a track width, a turning radius, external dimensions, and overhang at the front and/or at the rear, attachments at a trailer hitch, a coupled-on trailer, roof structures, etc.;
a sensor system: type and age of the sensors used, condition of the sensors (for example, with respect to defects, soiling);
a vehicle producer;
a generation system/method which was used when generating the at least one trajectory: real vehicle, simulation, creation in a map, manual description, etc.;
a direction of passage through the at least one trajectory.

A factor or a parameter can be taken into consideration when determining the confidence measure in each case for individual or multiple ones of these influencing factors. It can also be provided that a compatibility factor is determined from one or more of these influencing factors, which is taken into consideration when determining the confidence measure. The confidence measure can be positively influenced, for example, if other vehicles having different configurations have already (successfully) used the at least one trajectory.

In again a further embodiment of the invention, the confidence measure is determined and/or assigned individually in each case for sections of the trajectory. It is possible in this way to observe sections of the at least one trajectory individually and take into consideration their respective confidence measure in sections during use.

In accordance with an additional embodiment, a section of the at least one trajectory is discarded by the receiving vehicle if the confidence measure assigned to this section falls below a predetermined threshold value. In this way, the at least one trajectory can be used only if there is a minimum measure of confidence therein.

In accordance with yet an additional feature of the invention, the at least one vehicle defines a degree of automation for traveling along the at least one trajectory proceeding from the confidence measure of the at least one trajectory. For example, it can be provided that in the case of semiautomated driving or in the case of automated driving, in which the driver only has to be available to take over the steering, a lower value of the confidence measure is sufficient. In the case of fully automated driving without the driver as a fallback level, in contrast, a greater value of the confidence measure has to be met.

In accordance with another feature of the invention, the at least one vehicle generates and provides feedback about the use of the at least one trajectory during and/or after traveling along the at least one trajectory. In this way, current information can be provided, which can be used as the basis for checking and/or determining the confidence measure of the at least one trajectory. In particular, it can be provided that the vehicle transmits the feedback to the central server. The central server can then evaluate the feedback, together with any further feedback from other vehicles on the same trajectory, and check and/or define the confidence measure of the at least one trajectory. The confidence measure can in particular be checked and/or determined proceeding from swarm data of a plurality of vehicles transmitted in this way.

In accordance with yet another feature of the invention, the at least one vehicle learns and provides the at least one trajectory again if the confidence measure of the received at least one trajectory is below a predetermined threshold value. In this way, it is possible to react directly to an excessively low confidence measure by learning the assigned trajectory again. The learning in particular comprises detecting sensor data of the surroundings of the vehicle and recording control data and/or metadata for a traveled path. The newly learned at least one trajectory can then be transmitted to the central server and then in particular can be provided to other vehicles.

Other features which are considered as characteristic for the invention are set forth in the appended claims.

Although the invention is illustrated and described herein as embodied in a method and system for providing trajectories for at least one vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic illustration to illustrate embodiments of the system for providing trajectories for at least one vehicle;

FIG. 2 shows a schematic flow chart to illustrate an embodiment of the method;

FIG. 3 shows a schematic flow chart to illustrate an embodiment of the method;

FIG. 4 shows a schematic flow chart to illustrate an embodiment of the method; and

FIG. 5 shows a schematic flow chart to illustrate an embodiment of the method.

### DETAILED DESCRIPTION OF THE INVENTION

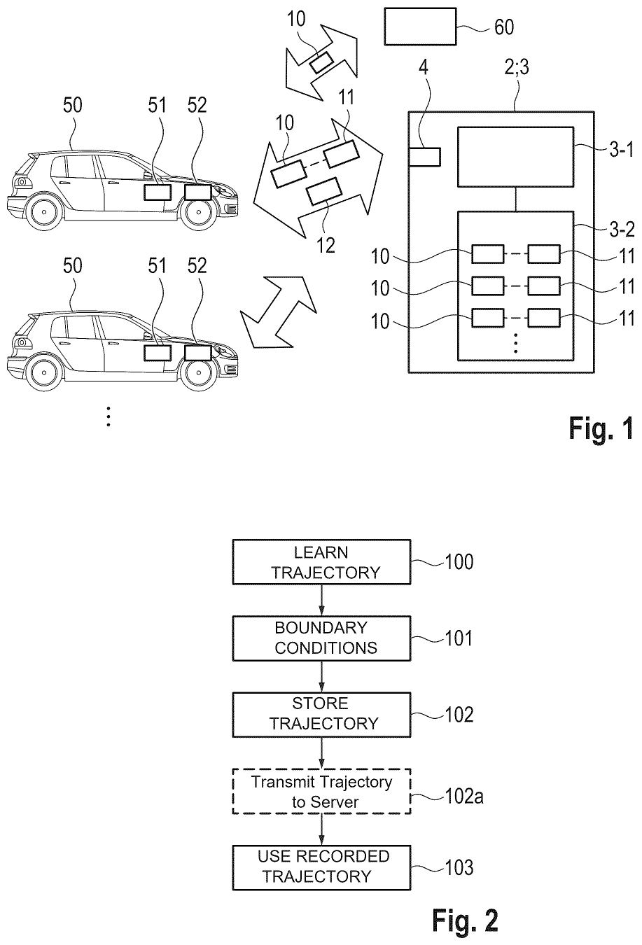

Referring now to the figures of the drawing in detail and first, in particular, to FIG. 1 thereof, there is shown a schematic illustration of a system 1 for providing trajectories 10 for at least one vehicle 50.

The system 1 comprises at least one device 2 for providing at least one trajectory 10 generated by a vehicle 50 or another source 60. The device 2, by way of example, is a central server 3. The at least one device 2, in particular the central server 3, in particular comprises a computing device 3-1 or processor and a memory 3-2. For example, a plurality of trajectories 10 are stored in the memory 3-2, which can be provided, for example, for various locations and/or various scenarios. One example of trajectories 10 are trajectories 10 which were learned for parking the vehicle 50 in a parking space (private or public) and can be used for semiautomated or automated parking. In principle, however, trajectories 10 can also be provided for other scenarios.

The at least one trajectory 10 is assigned a confidence measure 11 or can be assigned it.

The system 1 furthermore comprises at least one vehicle 50. The at least one vehicle 50 is configured to receive the provided at least one trajectory 10 and to use the at least one trajectory 10 in consideration of the assigned confidence measure 11. In particular, the at least one vehicle 50 has a control device 51, which carries out the method steps described for the vehicle 50. In particular, the vehicle 50 can be configured to implement the at least one trajectory 10, i.e. to drive manually, in a semiautomated manner, or in an automated manner. The manual implementation designates in this case in particular manually traveling along the trajectory 10 by a driver, which is assisted, for example, with the aid of instructions.

The at least one device 2, in particular the central server 3, and the at least one vehicle 50 in particular have communication devices 4, 52 in order to communicate with one another.

The confidence measure can be determined, for example, as a function of one or more parameters or influencing factors:

$$k = f ( p 1 , p 2 , p 3 , \text{…} ) ,$$

wherein k is the confidence measure and p1, p2, p3, . . . designate the parameters or influencing factors. A simple implementation having, for example, four parameters or influencing factors can be the formation of a weighted sum from the individual parameters:

$$k = a 1 ⋆ p 1 + a 2 ⋆ p 2 + a 3 ⋆ p 3 + a 4 ⋆ p 4 ,$$

wherein a1, a2, a3, and a4 are weighting factors. In principle, however, other functions can also be provided. In particular, the confidence measure has a higher value if the confidence in the trajectory is high and a lower value if the confidence in the trajectory is low. It can be provided, for example, that the confidence measure is expressed by values in a range from 0 (no confidence) to 1 (highest confidence). It can be provided that the parameters or influencing factors and the function are scaled.

The confidence parameter is initially determined in particular by the respective generating source (for example, vehicle or simulation). For this purpose, for example, properties of the source (known/unknown/trajectory provider), a vehicle configuration, and a quality of an underlying map are also incorporated as respective parameters or influencing factors.

It can be provided that the central server 3 checks and/or determines and/or assigns the confidence measure 11.

It can be provided that the central server 3 repeatedly and/or regularly checks and/or determines and/or assigns the confidence measure 11. In particular, it can be provided that the respective assigned confidence measures 11 of all trajectories 10 stored in the memory 3-2 are to be regularly checked and if necessary are to be defined again by means of the function proceeding from current values of the parameters or influencing factors.

It can be provided that the receiving at least one vehicle 50 checks and/or determines and/or assigns the confidence measure 11. This is carried out in particular by means of the control device 52. For this purpose, the at least one vehicle 50, in particular the control device 52, determines the confidence measure 11 again by means of the function using current values of the parameters or influencing factors.

The confidence measure 11 may be determined in consideration of an age and/or a last use of the at least one trajectory 10. The age and/or the last use then in particular form a parameter and/or an influencing factor in the above-mentioned function.

The confidence measure 11 may be determined in consideration of a robustness and/or a stability of the at least one trajectory 10. The robustness and/or the stability then in particular form a parameter and/or an influencing factor in the above-mentioned function.

The confidence measure 11 may be determined in consideration of the surroundings in which the at least one trajectory 10 is located. Properties and/or features of the surroundings then in particular form one or more parameters and/or one or more influencing factor(s) in the above-mentioned function.

The confidence measure 11 may be determined in consideration of a similarity between properties of a vehicle 50, with which or for which the at least one trajectory 10 was generated, and the receiving vehicle 50. The similarity (similarities) between properties and/or features of the vehicle 50 then in particular form one or more parameters and/or one or more influencing factor(s) in the above-mentioned function.

The confidence measure 11 may be determined and/or assigned individually in each case for sections of the trajectory 10. For this purpose, the trajectory 10 can in particular be decomposed into sections, to each of which a confidence measure 11 is then assigned. This can be carried out by means of the device 2, in particular by means of the central server 3, and/or by means of the vehicle 50.

It can be provided that a section of the at least one trajectory 10 is discarded by the receiving vehicle 50 if the confidence measure 11 assigned to this section falls below a predetermined threshold value. In particular, the entire trajectory 10 can also be discarded if the confidence measure 11 assigned to the trajectory falls below the predetermined threshold value. The section of the trajectory 10 or the entire trajectory is then not used by the receiving vehicle 50.

It can be provided that the at least one vehicle 50 defines a degree of automation for traveling along the at least one trajectory 10 proceeding from the confidence measure 11 of the at least one trajectory 10. For example, the control device 52 can compare the confidence measure 11 for this purpose to a predetermined threshold value and release or block a degree of automation proceeding from a result. A control signal generating proceeding therefrom can then be supplied to a vehicle controller of the vehicle 50.

It can be provided that the at least one vehicle generates and provides feedback 12 about the use of the at least one trajectory 10 during and/or after traveling along the at least one trajectory. The feedback 12 is in particular transmitted to the device 2, in particular the central server 3.

It can be provided that the at least one vehicle 50 learns and provides the at least one trajectory 10 again if the confidence measure 11 of the received at least one trajectory 10 is below a predetermined threshold value. If the control device 52 establishes, for example, that the confidence measure 11 of a trajectory 10 transmitted by the device 2, in particular the central server 3, is below the predetermined threshold value, it can thus initiate the learning of the trajectory 10, for example, in that surroundings data and/or control data for a path corresponding with the trajectory 10 are detected while a driver of the vehicle 50 travels along this path with manual control. The trajectory 10 learned in this way can then be transmitted in the context of the provision to the device 2, in particular the central server 3.

FIG. 2 shows a schematic flow chart to illustrate an embodiment of the method. The method is executed in a vehicle here.

In a step 100, a trajectory is learned by the vehicle, in particular in that sensor data and/or control data and/or metadata which describe the trajectory are detected and recorded. The learning is carried out, for example, by means of a device of the vehicle, in particular by means of a control device configured for this purpose. The trajectory can be, for example, a trajectory which comprises a path for parking in a parking space.

In a step 101, boundary conditions are determined which correspond with the recorded trajectory, such as properties of the vehicle, a quality and/or an age of the sensor system, surroundings conditions (backlight, brightness), etc. The control device can request this information, for example, at a vehicle controller and/or determine it from detected sensor data and/or request it from third-party providers (such as a weather service).

In a step 102, the recorded trajectory is stored in a memory of the vehicle. A confidence measure is assigned to the trajectory in this case. The confidence measure is determined, for example, by means of the control device proceeding from the above-described parameters and assigned to the trajectory. Since the trajectory was recorded directly in the same vehicle, in general a high confidence measure will exist.

In a step 103, the vehicle can then use the recorded trajectory again, wherein this takes place in consideration of the assigned confidence measure.

It can be provided in a step 102a that the recorded trajectory is transmitted to a central server (backend).

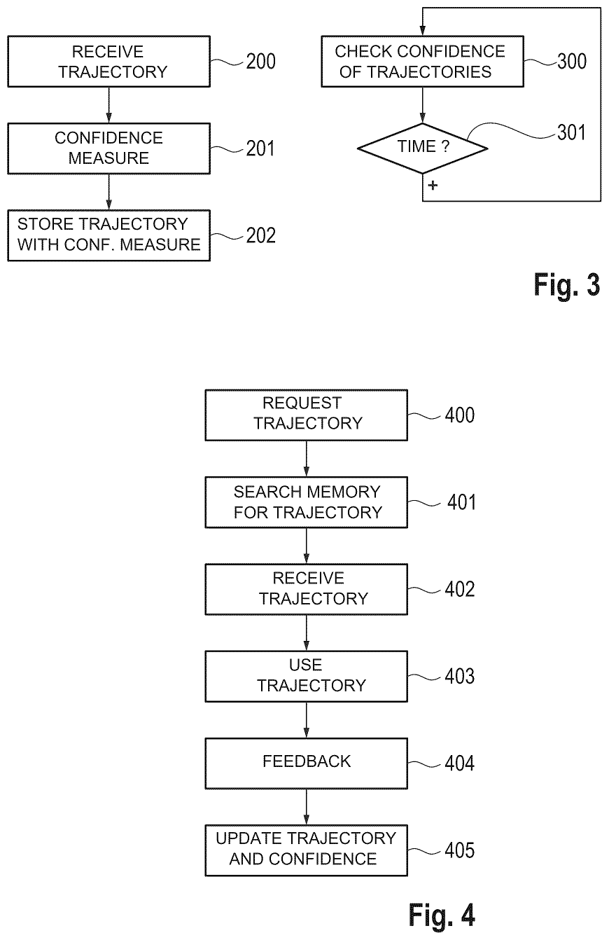

FIG. 3 shows a schematic flow chart to illustrate an embodiment of the method. The method is executed in a central server here.

In a step 200, the central server receives a trajectory. The trajectory can be, for example, a detected or learned trajectory of a vehicle, as was described with reference to FIG. 2. Alternatively, the trajectory can also originate from another source, for example, the trajectory can have been generated in the context of a simulation or provided by an infrastructure operator (such as a parking garage operator).

In a step 201, a confidence measure of the trajectory is checked and/or determined and/or assigned. If a confidence measure is not yet assigned to the trajectory, this can take place for the first time. Otherwise, the confidence measure can be checked and, if necessary, adapted.

In a step 202, the received trajectory is stored together with the checked and/or determined and/or assigned confidence measure in a memory of the central server. Proceeding therefrom (and further trajectories which are stored in the same manner in the memory), the central server can provide a vehicle with at least one trajectory, together with a confidence measure assigned to the at least one trajectory.

In a step 300 running in parallel, the confidence measures of all trajectories stored in the memory of the central server are checked in particular. It can be provided in particular in this case that the confidence measure is reduced or increased in consideration of an age and/or a last use of the observed trajectory. Further influencing factors were already described in the general description. In particular, it can be provided that feedback of a vehicle which has traveled along a trajectory to be checked is to be taken into consideration. This takes place regularly in particular. It can be provided for this purpose in a step 301 that the time passed since the last check is compared to a predetermined value. If the predetermined value is reached, step 300 is carried out again.

FIG. 4 shows a schematic flow chart to illustrate an embodiment of the method.

In a step 400, a vehicle requests a trajectory from the central server. An exemplary application is parking in a parking space in a parking garage or an underground garage, wherein a suitable path has to be provided for this purpose, in order to drive the vehicle from a starting position into the parking space. The vehicle can request the provision of a trajectory, for example, from a central server of an operator of the parking garage. For this purpose, the vehicle in particular transmits a current position.

In a step 401, the central server (backend) searches for a suitable trajectory in the memory on the basis of the transmitted position of the vehicle. Further information can also be taken into consideration in this case. In particular, occupancy information on the parking spaces is taken into consideration, so that the transmitted trajectory has a destination position leading to a free parking space.

In step 402, the vehicle receives the trajectory from the central server.

In step 403, the vehicle uses the trajectory in consideration of the assigned confidence measure. With a large value of the confidence measure, the trajectory is traveled, for example, with the aid of a SAE level 3+ function (or level 4). At a lower value of the confidence measure, the trajectory is only traveled, for example, with the aid of a SAE level 2 function. At a very low value of the confidence measure, the vehicle can suggest renewed learning of the trajectory to the central server, for example.

In a step 404, the vehicle generates feedback about the use of the at least one trajectory during and/or after traveling along the at least one trajectory and provides this feedback. In particular, it can be provided that the feedback about the trajectory is transmitted to the central server. The feedback can in particular comprise current information on the surroundings (e.g., on the vegetation, on construction sites, on other vehicles, etc.) and information on a deviation from a target path of the trajectory. The feedback can furthermore comprise newly detected data on the trajectory, for example, the traveled actual path or information on the deviation between a target path and the traveled actual path of the trajectory.

In a step 405, the central server receives the feedback transmitted by the vehicle and checks and/or determines the confidence measure of the trajectory again and assigns it to the trajectory. For this purpose, in particular properties of the vehicle are also taken into consideration, such as an age of the vehicle, a sensor system, and/or the surroundings conditions.

It can be provided that steps 400 to 405 are carried out for a plurality of vehicles, in particular for the vehicles of a vehicle fleet.

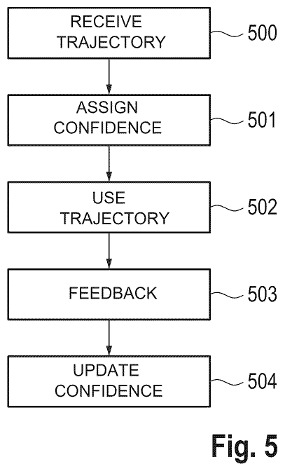

FIG. 5 shows a schematic flow chart to illustrate an embodiment of the method.

In a step 500, the vehicle receives a trajectory transmitted from another source, for example, another vehicle.

In step 501, the vehicle determines a confidence measure for the received trajectory and assigns the determined confidence measure to the received trajectory. For this purpose, for example, the vehicle can take into consideration a list of known sources. The list comprises, for example, sources having a respective assignment of initial values of the confidence measure which can be assigned to a trajectory originating from each of these sources. Furthermore, existing test certificates and/or a relationship to the providing source can be taken into consideration (for example, if the providing source originates from the circle of family or relatives of the driver of the vehicle). A similarity between properties of the vehicle, with which or for which the at least one trajectory was generated, and the receiving vehicle can also be taken into consideration here. An age of the received trajectory of the other source can also be taken into consideration, if this information is present.

In step 502, the vehicle uses the trajectory in consideration of the assigned confidence measure. With a large value of the confidence measure, the trajectory is traveled, for example, with the aid of a SAE level 3+ function. At a lower value of the confidence measure, the trajectory is only traveled, for example, with the aid of a SAE level 2 function. At a very low value of the confidence measure, the vehicle can suggest renewed learning of the trajectory to the central server, for example.

In a step 503, the vehicle generates feedback about the use of the at least one trajectory during and/or after traveling along the at least one trajectory and provides this feedback. In particular, it can be provided that the feedback about the trajectory is transmitted to the central server. The feedback can in particular comprise current information on the surroundings (e.g., on vegetation, on construction sites, on other vehicles, etc.) and information on a deviation from a target path of the trajectory. The feedback can furthermore comprise newly detected data on the trajectory, for example, the traveled actual path or information on the deviation between a target path and the traveled actual path of the trajectory. If the trajectory is not yet stored in a memory of the central server, the trajectory can thus also be transmitted.

In a step 504, the central server receives the feedback transmitted from the vehicle (and, under certain circumstances, also the trajectory) and checks and/or determines the confidence measure of the trajectory again and assigns it to the trajectory. Properties of the vehicle are also taken into consideration in particular here, such as an age of the vehicle, a sensor system, and/or the surroundings conditions.

The following is a summary list of reference numerals and the corresponding structure used in the above description of the invention:
1 system
2 device
3 central server
3-1 computing device
3-2 memory
4 communication device
10 trajectory
11 confidence measure
12 feedback
50 vehicle
51 control device
52 communication device
60 other source (e.g., simulation, infrastructure operator, other vehicle, etc.)
100-103 method steps
200-202 method steps
300-301 method steps
400-405 method steps
500-504 method steps

1. A method for providing trajectories for at least one vehicle, the method comprising:
providing at least one trajectory that is generated by a vehicle or by another source selected from the group consisting of a simulation, an infrastructure operator, and another vehicle;
assigning a confidence measure to the at least one trajectory;
receiving the at least one trajectory by at least one vehicle; and
using the at least one trajectory by the at least one vehicle in consideration of the assigned confidence measure.

2. The method according to claim 1, wherein the step of providing the at least one trajectory comprises providing the at least one trajectory by a central server.

3. The method according to claim 2, which comprises processing the confidence measure with the central server by at least one of checking the confidence measure, determining the confidence measure, or assigning the confidence measure to a respective trajectory.

4. The method according to claim 3, which comprises repeatedly or regularly processing the confidence measure with the central server by the checking, determining, or assigning the confidence measure.

5. The method according to claim 1, which comprises, upon receiving the at least one trajectory, one of checking, determining, or assigning the confidence measure by the at least one vehicle.

6. The method according to claim 1, which comprises determining the confidence measure in consideration of at least one of an age or a last use of the at least one trajectory.

7. The method according to claim 1, which comprises defining by the at least one vehicle a degree of automation for traveling along the at least one trajectory in dependence on the confidence measure of the at least one trajectory.

8. The method according to claim 1, which comprises generating and providing feedback by the at least one vehicle about a use of the at least one trajectory during and/or after traveling along the at least one trajectory.

9. The method according to claim 1, which comprises learning and providing the at least one trajectory again by the at least one vehicle when the confidence measure of the received at least one trajectory lies below a predetermined threshold value.

10. A system for providing trajectories, the system comprising:
at least one device for providing at least one trajectory generated by a vehicle or by another source selected from the group consisting of a simulation, an infrastructure operator, and another vehicle;
the at least one trajectory having a confidence measure assigned thereto or being configured for an assignment of a confidence measure; and
at least one vehicle configured for receiving the at least one trajectory and to use the at least one trajectory in consideration of the confidence measure assigned thereto.
